(19) United States
(12) Patent Application Publication
(10) Pub. No.: US 2009/0240425 A1
(43) Pub. Date: Sep. 24, 2009

(54) System For Marking a Region

(75) Inventors: Wilfried Steins, Ismaning (DE); Bernd Biechele, Muenchen (DE); Marcello Tava, Muenchen (DE); Uwe Koch, Vaterstetten (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/942,141

(22) Filed: Nov. 19, 2007

(30) Foreign Application Priority Data
Nov. 24, 2006 (DE) 10 2006 049 304.4

(51) Int. Cl. G01C 21/36; G09G 5/00

(52) U.S. Cl. 701/201; 701/209; 345/650

(57) ABSTRACT

In the case of a system for marking a region within an image of a road map detail displayed on a vehicle video screen, the regions are shown in a circular shape. The center and the dimensions of the region can be changed by a control element, which can be rotated about a longitudinal axis and can be deflected transversely to the longitudinal axis. As a result of the transverse movement of the control element, the position of the center point and, as a result of the rotating movement of the control element, the dimensions of the region within the video screen, are adjustable.

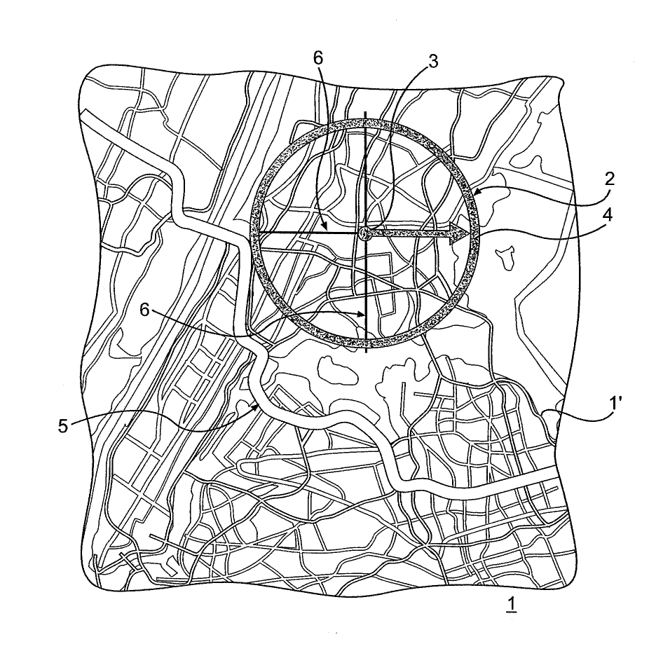

### BACKGROUND AND SUMMARY OF THE INVENTION

The invention relates to a system for marking a region within an image of a road map detail displayed on a vehicle video screen. Such systems are used in vehicle navigation systems. The navigation system automatically computes the optimal driving route for the respective location of the vehicle based on knowledge of the destination and, by way of corresponding visual and/or acoustic indications, provides assistance to the driver for driving to the destination without the use of conventional map material. The marking of a region causes the navigation system to drive around that region.

In this context, it is known from U.S. Pat. No. 6,542,812 to mark the region by use of a suitable drawing device so that the drive takes place around the marked outlines. It is easy to recognize that such a system is not particularly suitable for use in comfort-optimized vehicles.

Furthermore, a correction possibility can be provided only very inconveniently, if at all. In this case, a correction is also a change of the displayed map detail with respect to its size as well as also with respect to its position.

Required long periods of looking at the system and for operating the system are also a disadvantage associated with the known system.

It is an object of the invention to provide a system of the above-mentioned type, by which a marking of a region within a road map detail displayed on a vehicle video screen becomes possible in an easy and rapid manner.

According to the invention, a system is provided for marking a region within an image of a road map detail displayed on a vehicle video screen, characterized in that the region is circular, and in that the center and the dimensions of the region can be changed by a control element which can be rotated about a longitudinal axis and can be deflected transversely to the longitudinal axis. As a result of the transverse movement of the control element, the position of the center point and, as a result of the rotating movement of the control element, the dimensions of the region within the video screen are adjustable.

The translational movement of the control element shifts the center of the region map detail within the map display; the rotating movement changes the size of the map detail. A circular representation in a top view of a region is replaced by an oval representation in a perspective view, with a distortion caused by the perspective and scale, as required.

Advantageous embodiments of the invention are described herein. These embodiments relate to the possibility of changing the dimensions of the region by use of the control element, to fixing an implemented selection of the region parameters center and size, and to the manner of how this fixing can be carried out by use of the control element and can be included in the navigation system.

Finally, the inventive system provides a solution in the event that the vehicle is already situated within the marked region. In this case, the navigation system suggests a route by which the vehicle leaves this region as fast as possible.

### BRIEF DESCRIPTION OF THE DRAWING

The single figure shows a road map displayed on a video screen and a region marked therein according to the invention.

### DETAILED DESCRIPTION OF THE DRAWING

In the case of a navigation system for a vehicle (not shown in detail), a map detail 1′ is situated on a video screen 1. A circle 2, which is characterized by a center 3 and a radius vector 3′, is also situated within the video screen. By use of a manually operable control element (not shown), the circle 2 can be controlled with respect to its position and its diameter. The control element preferably is a push-turn button, as described in German Patent document DE 3836555 A1 (having U.S. Pat. No. 5,270,689). It can be rotated about its axis and can be moved longitudinally along its axis. As a rule, the longitudinal movement has the purpose of causing an “enter” function.

In addition, the control element can be moved translationally. This may be a tilting motion or a transverse motion similar to a stirring motion. A corresponding control element is known from German Patent document DE 197 52 056 A1.

Assuming that a driver wants to avoid a certain region, then by means of the transverse motion of the control element, the driver moves the center 3 of the circle 2 in the map detail 1′. Before, during or after this moving motion, the driver can enlarge or reduce the radius by turning the control element. In the map detail, the resulting surroundings 4 of the circle 2, as required, are highlighted in color. If the driver has adjusted the parameters of the marked region as desired, he only still has to trigger the enter function by axially moving the control element. The region is thereby fixed and fed into the navigation system (not shown). The navigation system will then define the driving route such that the driving takes place around the region. For example, the graphically highlighted driving route 5 is defined.

Instead of a circle 2 with the center 3 and the radius vector 3′, a reticule 6 can be displayed within the surroundings 3′.

Should the vehicle be situated within the marked region when the enter function is triggered, the navigation system will indicate a driving route by which the vehicle may quickly leave the region (not shown).

In this manner, it becomes possible to manually intervene in the route selection of a navigation system in a reliable manner while looking at the system as little as possible. The entire manipulation takes place by use of a single control element without a time-consuming change of operating elements.

1-6. (canceled)

7. A system for marking a region of a road map displayed on a vehicle display, the system comprising:
a control element rotatable about its longitudinal axis and deflectable transversely to the longitudinal axis;
wherein the marked region of the display is circular and wherein a center point and dimensions of the circular region are changeable via the control element; and
wherein the transverse movement of the control element changes the center point of the circular region and the rotational movement of the control element adjusts the dimensions of the region on the displayed road map.

8. The system according to claim 7, wherein, for the rotational movement of the control element, lock-in positions are provided, and wherein a diameter of the region is changeable in steps corresponding to the lock-in positions.

9. The system according to claim 7, wherein an enter function is provided by which the position and size of the region is fixedly defined.

10. The system according to claim 8, wherein an enter function is provided by which the position and size of the region is fixedly defined.

11. The system according to claim 9, wherein the enter function is triggerable by an axial movement of the control element.

12. The system according to claim 7, wherein, by way of an enter function, the region is included in an assigned navigation system, wherein the navigation system plans a driving route around the region.

13. The system according to claim 8, wherein, by way of an enter function, the region is included in an assigned navigation system, wherein the navigation system plans a driving route around the region.

14. The system according to claim 9, wherein, by way of an enter function, the region is included in an assigned navigation system, wherein the navigation system plans a driving route around the region.

15. The system according to claim 11, wherein, by way of an enter function, the region is included in an assigned navigation system, wherein the navigation system plans a driving route around the region.

16. The system according to claim 7, wherein via the enter function, a driving route for exiting the marked region is one of provided and selected when a current location of the vehicle is within the marked region.

17. The system according to claim 12, wherein via the enter function, a driving route for exiting the marked region is one of provided and selected when a current location of the vehicle is within the marked region.

18. A method of operating a vehicle navigation system having a display and a control element, the control element being rotatable about a longitudinal axis and movable axially along the longitudinal axis, the method comprising the acts of:
displaying a road map on the display;
selecting a region of the displayed road map using the control element, wherein the selected region is circular; and
changing a center point and dimensions of the circular region via the control element, wherein a transverse movement of the control element changes the center point and a rotational movement of the control element adjusts the dimensions of the circular region on the displayed road map.

19. The method according to claim 18, further comprising the act of generating a driving route via the navigation system which avoids the selected region.

20. The method according to claim 19, wherein when the navigation system determines the vehicle to be within the selected region, generating a driving route for exiting the selected region.
